(19) United States
(12) Patent Application Publication
(10) Pub. No.: US 2026/0074380 A1
(43) Pub. Date: Mar. 12, 2026

(54) SEALED ARRAY-TO-ARRAY BUSBAR ASSEMBLIES

(71) Applicant: FORD GLOBAL TECHNOLOGIES, LLC, Dearborn, MI (US)

(72) Inventors: Sangyeon Kim, Northville, MI (US); Samuel Jeffrey Tomlinson, Farmington Hills, MI (US); Michael Barr, Canton, MI (US); Liam E. West, Ferndale, MI (US)

(21) Appl. No.: 18/826,361

(22) Filed: Sep. 6, 2024

(51) Int. Cl. H01M 50/505; H01M 50/186; H01M 50/249; H01M 50/262

(52) U.S. Cl. CPC H01M 50/505; H01M 50/186; H01M 50/249; H01M 50/262; H01M 2220/20

(57) ABSTRACT

Sealed busbar assemblies are provided for use within traction battery packs. An exemplary sealed busbar assembly may be configured to electrically connect a first battery array and a second battery array of the traction battery pack. Primary seals and secondary seals of the sealed busbar assembly may cooperate to seal high voltage connections relative to both the first battery array and the second battery array. The high voltage connections may be established by the busbar, a pair of fasteners, and high voltage array busbars of both the first battery array and the second battery array.

### TECHNICAL FIELD

This disclosure relates generally to electrified vehicle traction battery packs, and more particularly to sealed array-to-array busbar assemblies for use within traction battery packs.

### BACKGROUND

An electrified vehicle includes a traction battery pack for powering electric machines and other electrical loads of the vehicle. The traction battery pack includes a plurality of battery cells and various other battery internal components that support electric vehicle propulsion. The battery cells must be reliably connected to one another in order to achieve the voltage and power levels necessary to electrically propel the vehicle.

### SUMMARY

A traction battery pack according to an exemplary aspect of the present disclosure includes, among other things, a first battery array, a second battery array, and a sealed busbar assembly configured to electrically connect the first battery array and the second battery array. The sealed busbar assembly includes a busbar, a busbar frame, a pair of fasteners, a pair of primary seals, and a pair of secondary seals.

In a further non-limiting embodiment of the foregoing traction battery pack, a first primary seal of the pair of primary seals and a first secondary seal of the pair of secondary seals cooperate to seal an interface between the sealed busbar assembly and a first array outer housing of the first battery array.

In a further non-limiting embodiment of either of the foregoing traction battery packs, a second primary seal of the pair of primary seals and a second secondary seal of the pair of secondary seals cooperate to seal an interface between the sealed busbar assembly and a second array outer housing of the second battery array.

In a further non-limiting embodiment of any of the foregoing traction battery packs, a first fastener of the pair of fasteners is received through the busbar and a first high voltage array busbar of the first battery array to establish a first high voltage connection, and a second fastener of the pair of fasteners is received through the busbar and a second high voltage array busbar of the second battery array to establish a second high voltage connection.

In a further non-limiting embodiment of any of the foregoing traction battery packs, the first fastener is received by a first fastener housing of a first internal component of the first battery array, and the second fastener is received by a second fastener housing of a second internal component of the second battery array.

In a further non-limiting embodiment of any of the foregoing traction battery packs, the first internal component is a first array busbar frame of the first battery array, and the second internal component is a second array busbar frame of the second battery array.

In a further non-limiting embodiment of any of the foregoing traction battery packs, the busbar frame is overmolded around the busbar.

In a further non-limiting embodiment of any of the foregoing traction battery packs, each primary seal of the pair of primary seals is positioned within a groove of the busbar frame.

In a further non-limiting embodiment of any of the foregoing traction battery packs, each secondary seal of the pair of secondary seals is received within a groove of a head portion of a respective fastener of the pair of fasteners.

In a further non-limiting embodiment of any of the foregoing traction battery packs, the busbar frame includes a first cover movable to enclose a first tab section of the busbar and a second cover movable to enclose a second tab section of the busbar.

A traction battery pack according to another exemplary aspect of the present disclosure includes, among other things, a first battery array including a first high voltage array busbar, a sealed busbar assembly including a busbar positioned against the first high voltage array busbar, a first fastener received through the busbar and the first high voltage array busbar, a first primary seal, and a first secondary seal. The first primary seal and the first secondary seal cooperate to seal a first high voltage connection established by the first fastener, the busbar, and the first high voltage array busbar.

In a further non-limiting embodiment of the foregoing traction battery pack, the first primary seal is arranged to seal an interface between the sealed busbar assembly and a first array outer housing of the first battery array.

In a further non-limiting embodiment of either of the foregoing traction battery packs, the first primary seal is positioned within a groove of a busbar frame of the sealed busbar assembly.

In a further non-limiting embodiment of any of the foregoing traction battery packs, the busbar frame is overmolded around the busbar.

In a further non-limiting embodiment of any of the foregoing traction battery packs, the first secondary seal is arranged to seal an interface between the first fastener and the busbar.

In a further non-limiting embodiment of any of the foregoing traction battery packs, the first secondary seal is received within a groove of a head portion of the first fastener.

In a further non-limiting embodiment of any of the foregoing traction battery packs, the first fastener is received by a fastener housing of an internal component of the first battery array.

In a further non-limiting embodiment of any of the foregoing traction battery packs, the internal component is an array busbar frame of the first battery array.

In a further non-limiting embodiment of any of the foregoing traction battery packs, the sealed busbar assembly includes a second primary seal, a second secondary seal, and a second fastener received through the busbar and a second high voltage array busbar of a second battery array.

In a further non-limiting embodiment of any of the foregoing traction battery packs, the second primary seal and the second secondary seal cooperate to seal a second high voltage connection established by the second fastener, the busbar, and the second high voltage array busbar.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a busbar assembly for electrically connecting adjacent battery arrays of a traction battery pack.

FIG. 3 illustrates the busbar assembly of FIG. 2 with busbar covers of the busbar assembly moved to an open position.

FIG. 4 is a cross-sectional view through section 4-4 of FIG. 2.

FIG. 5 is a partially exploded perspective view of a busbar assembly.

### DETAILED DESCRIPTION

This disclosure details sealed busbar assemblies for use within traction battery packs. An exemplary sealed busbar assembly may be configured to electrically connect a first battery array and a second battery array of the traction battery pack. Primary seals and secondary seals of the sealed busbar assembly may cooperate to seal high voltage connections relative to both the first battery array and the second battery array. The high voltage connections may be established by the busbar, a pair of fasteners, and high voltage array busbars of both the first battery array and the second battery array. These and other features are discussed in greater detail in the following paragraphs of this detailed description.

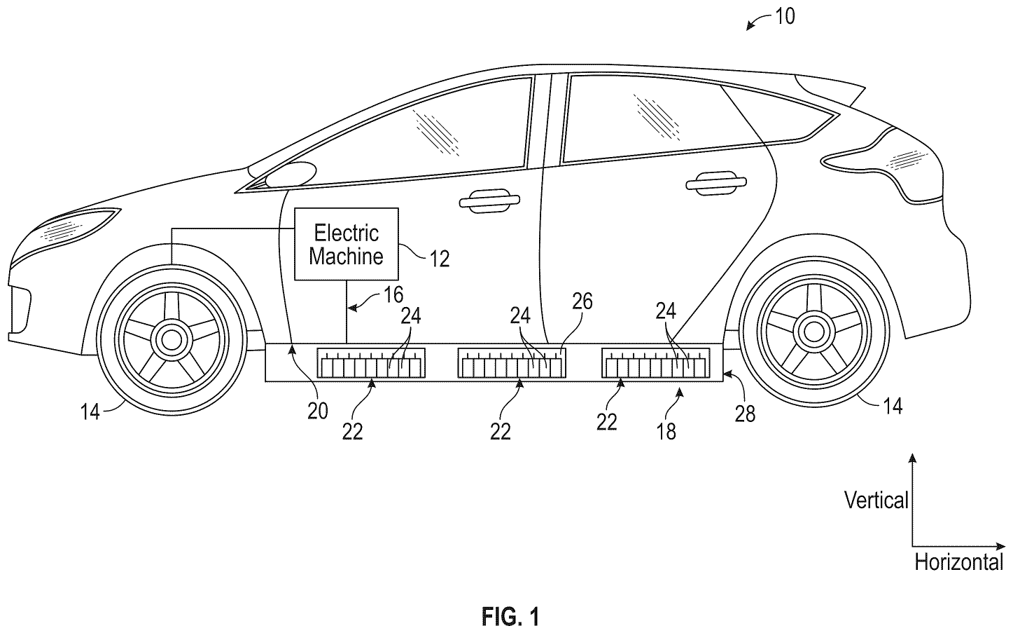

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery modules, assemblies, or groupings of rechargeable battery cells 24) capable of outputting electrical power to power the electric machine 12 and/or other electrical loads of the electrified vehicle 10. The one or more battery arrays 22 of the traction battery pack 18 may each include a plurality of battery cells 24 that store energy for powering various electrical loads of the electrified vehicle 10. The traction battery pack 18 could employ any number of battery arrays 22 and battery cells 24 within the scope of this disclosure. Accordingly, this disclosure should not be limited to the highly schematic configuration shown in FIG. 1.

In an embodiment, the battery cells 24 of each battery array 22 are lithium-ion pouch cells. However, battery cells having other geometries (cylindrical, prismatic, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

Thermal energy levels of the battery cells 24 of each battery array 22 can increase as the electrified vehicle 10 is operated. A thermal management system can be employed for managing the thermal energy levels of the battery cells 24 of the battery arrays 22. The thermal management system may be configured to route a coolant C through each battery array 22 in order to manage the thermal energy within the battery arrays 22 by, for example, using the coolant C to take on heat from the battery cells 24.

In an embodiment, the thermal management system is an immersion thermal management system in which battery cells 24 and/or other components of the battery arrays 22 can be immersed in the coolant C. Thermal energy can transfer between the coolant C and the battery cells 24 as the coolant C flows over and/or around the battery cells 24 inside the battery arrays 22. The coolant C can help manage thermal energy levels of the battery cells 24 as well as other components of the battery arrays 22, such as busbars, for example.

The thermal management system can deliver the coolant C to the interior area of the battery arrays 22 through one or more inlets of each battery array 22. The coolant C can fill one or more open areas inside the battery arrays 22 such that the battery cells 24 are immersed in, and directly contacted by, the coolant C. The coolant C can take on thermal energy from the battery cells 24 for managing the thermal energy levels. The coolant C may then exit the battery arrays 22 through one or more outlets of each battery array 22.

The coolant C exiting through the outlets of the battery arrays 22 can move to a thermal energy exchange device (not shown), such as a heat exchanger, where thermal energy can be transferred from the coolant C to atmosphere. A pump (not shown) can be operated to selectively circulate the coolant C between the battery arrays 22 and the thermal energy exchange device and then back to the battery arrays 22 as part of a closed-loop system.

The coolant C circulated in the immersion thermal management system may be a dielectric fluid or another type of non-conductive fluid (e.g., oil) that is designed for immersion cooling the battery cells 24. However, other non-conductive fluids may also be suitable, and the actual chemical make-up and design characteristics (e.g., dielectric constant, maximum breakdown strength, boiling point, etc.) may vary depending on the environment the traction battery pack 18 is to be utilized within.

The use of immersion cooling may necessitate the development of additional sealing solutions, such as for sealing high voltage connections between adjacent battery arrays 22 of the traction battery pack 18, for example. This disclosure is therefore directed to sealed busbar assemblies for electrically connecting battery arrays of traction battery packs.

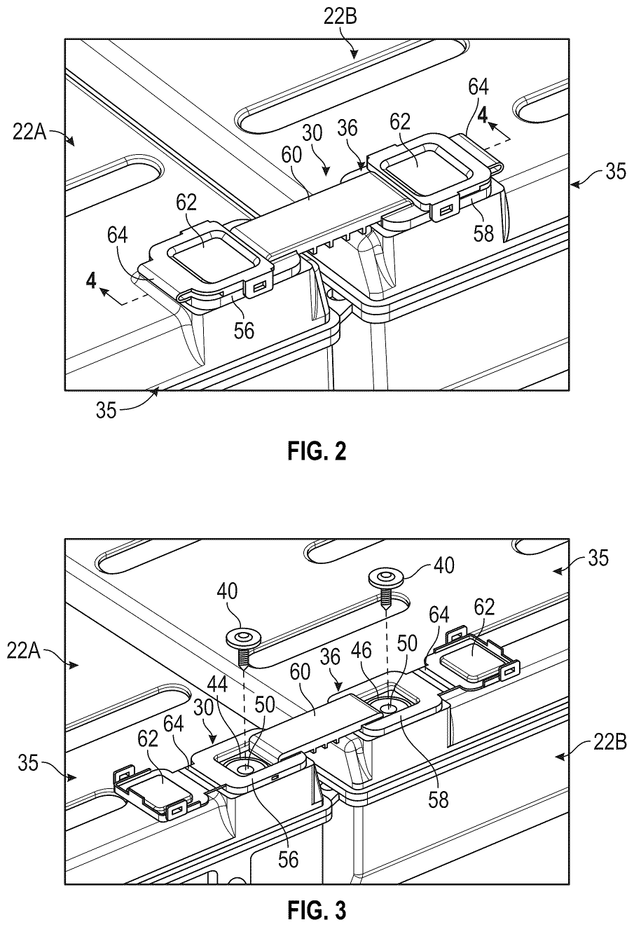

FIGS. 2-5 illustrate features associated with a sealed busbar assembly 30 that can be utilized to electrically connect adjacent battery arrays of a battery system. For example, the sealed busbar assembly 30 could be utilized to electrically connect adjacent battery arrays 22 of the traction battery pack 18 of the electrified vehicle 10 of FIG. 1.

In the illustrated embodiment, the sealed busbar assembly 30 is utilized to electrically connect a first battery array 22A and a second battery array 22B. However, in other embodiments, the sealed busbar assembly 30 could be utilized to provide other high voltage connections, such as those between a battery array and a bussed electrical center (BEC), for example.

The first battery array 22A and the second battery array 22B could be part of a string of battery arrays of the traction battery pack 18. Depending on the overall design requirements of the traction battery pack 18, additional battery arrays could be added to the string by utilizing an additional number of sealed busbar assemblies 30.

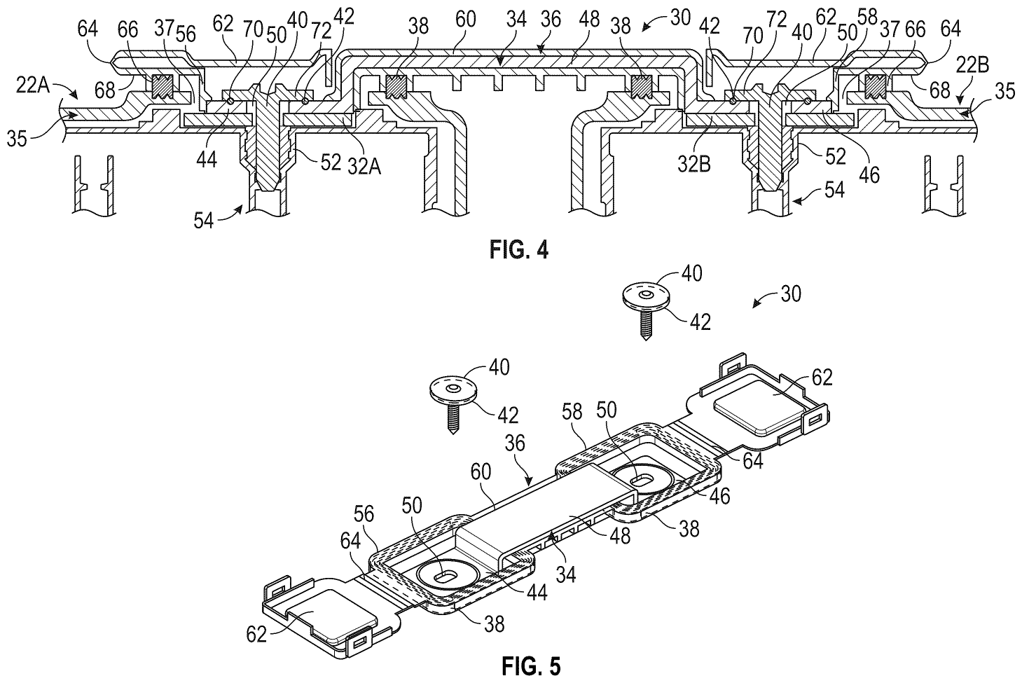

The sealed busbar assembly 30 may be part of an electrical distribution system (EDS) that is designed for electrically distributing power to/from the traction battery pack 18. The sealed busbar assembly 30 may electrically connect a first high voltage array busbar 32A of the first battery array 22A to a second high voltage array busbar 32B of the second battery array 22B (see FIG. 4). The sealed busbar assembly 30 may be be utilized to electrically connect the first battery array 22A and the second battery array 22B in either a parallel configuration or a series configuration.

Each high voltage array busbar 32A, 32B may be mounted relative to a top surface of a fastener housing 52 of a respective one of the first battery array 22A or the second battery array 22B. In an embodiment, the high voltage array busbars 32A, 32B are at least partially exposed within openings 37 (see FIG. 4) formed in the outer array housings 35.

The sealed busbar assembly 30 may include a busbar 34, a busbar frame 36, pair of primary seals 38, a pair fasteners 40, and a pair secondary seals 42. Each of these substituent parts of the sealed busbar assembly 30 is further described below.

The busbar 34 may be made of a metallic material, such as copper, for example. However, other conductive materials may also be utilized within the scope of this disclosure. The busbar 34 may include a first tab section 44, a second tab section 46, and a bridging section 48 that extends and connects between the first tab section 44 and the second tab section 46. Together, the first tab section 44, the second tab section 46, and the bridging section 48 establish a unitary body of the busbar 34.

The first tab section 44 and the second tab section 46 may be bent relative to the bridging section 48 to establish a “top hat” like shape of the busbar 34. The bridging section 48 may thus extend in a plane that is vertically offset (e.g., vertically above) a plane that extends through the first and second tab sections 44, 46. Vertical, for purposes of this disclosure, is with reference to ground in an ordinary orientation of the traction battery pack 18 when mounted on the electrified vehicle 10.

The first tab section 44 and the second tab section 46 may each be configured in the form of an eyelet that includes an opening 50. The opening 50 may be a hole that is sized to receive one of the fasteners 40 of the sealed busbar assembly 30. One fastener 40 may be inserted through the first tab section 44, through the first high voltage array busbar 32A, and then into a fastener housing 52 of an internal component 54 of the first battery array 22A for mounting the sealed busbar assembly 30 to the first battery array 22A (see FIG. 4), and the other fastener 40 may be inserted through the second tab section 46, through the second high voltage array busbar 32B, and then into a fastener housing 52 of an internal component 54 of the second battery array 22B for mounting the sealed busbar assembly 30 to the second battery array 22B (see FIG. 4).

In an embodiment, the fasteners 40 are bolts or screws. In another embodiment, the fasteners 40 are M6 bolts. Other fastener configurations could be utilized within the scope of this disclosure.

In an embodiment, the internal components 54 are array busbar frames that can position and hold additional busbars (not shown) that are configured to electrically connect the battery cells 24 of each battery array 22A, 22B. However, other configurations are contemplated within the scope of this disclosure. The internal components 54 may be fixedly secured to the outer array housings 35, such as via the use of mechanical fasteners and/or adhesives.

The busbar frame 36 may be arranged to substantially surround the busbar 34. The busbar frame 36 may be overmolded about the busbar 34, for example. The busbar frame 36 may be made of an insulating plastic material, such as a suitable thermoplastic or thermoset, for example. However, other insulating materials may also be utilized within the scope of this disclosure.

The busbar frame 36 may include a first platform section 56, a second platform section 58, and a mid-section 60 that connects and extends between the first platform section 56 and the second platform section 58. The first platform section 56 may be formed around the first tab section 44 of the busbar 34, the second platform section 58 may be formed around the second tab section 46 of the busbar 34, and the mid-section 60 may be formed around the bridging section 48 of the busbar 34.

Each of the first platform section 56 and the second platform section 58 may include a cover 62. Each cover 62 may be independently moved between a closed position (see FIGS. 2 and 4) and an open position (see FIGS. 3 and 5) relative to the first platform section 56 or the second platform section 58.

In the closed position, the cover 62 encloses the first tab section 44 or the second tab section 46 and prevents finger access to the busbar 34. The covers 62 may therefore provide “finger-proof” features for preventing inadvertent exposure to high voltage areas of the traction battery pack 18.

In the open position, the cover 62 is displaced from the first platform section 56 or the second platform section 58 to provide access to the first tab section 44 or the second tab section 46 of the busbar 34. The openings 50 of the first and second tab sections 44, 46 of the busbar 34 are therefore easily accessible for assembly or disassembly of the sealed busbar assembly 30 relative to the first and second battery arrays 22A, 22B.

Each cover 62 may be movably connected to the first platform section 56 or the second platform section 58 by a living hinge 64. The covers 62 may be manually rotated about the living hinge 64 for achieving rotational movement between the closed and open positions.

One primary seal 38 may be connected to each of the first platform section 56 and the second platform section 58 of the busbar frame 36. Each primary seal 38 may be accommodated within a groove 66 provided on an interior facing side 68 of the first platform section 56 or second platform section 58 (see FIG. 4). The interior facing sides 68 face toward the outer array housings 35 of the first and second battery arrays 22A, 22B.

The primary seals 38 may be configured to seal an interface between the sealed busbar assembly 30 and the outer array housing 35, thereby substantially sealing the high voltage connections. In an embodiment, the primary seals 38 are gasket seals. However, other configurations are contemplated within the scope of this disclosure.

The secondary seals 42 may each be positioned to seal an interface between one of the fasteners 40 and the busbar 34, thereby further contributing to sealing the high voltage connections. Each secondary seal 42 may be accommodated within a groove 70 formed in a head portion 72 of one of the fasteners 40. In an embodiment, the secondary seals 42 are O-ring seals. However, other configurations are contemplated within the scope of this disclosure.

The primary seals 38 and the secondary seals 42 may be configured to seal the interface between the sealed busbar assembly 30 and the high voltage connections simultaneously with insertion of the fasteners 40. For example, the primary seals 38 and the secondary seals 42 may be compressed to establish the sealed interfaces at the same time the fasteners 40 are tightened down to establish the high voltage electrical connections, thereby simplifying assembly and increasing packaging efficiencies.

The exemplary sealed busbar assemblies of this disclosure include a dual seal arrangement for sealing high voltage connections within a traction battery pack. The dual seal arrangement can accommodate required assembly tolerances and increase packaging efficiency while maintaining the sealed interface around high voltage connection areas.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a first battery array;
a second battery array; and
a sealed busbar assembly configured to electrically connect the first battery array and the second battery array,
wherein the sealed busbar assembly includes a busbar, a busbar frame, a pair of fasteners, a pair of primary seals, and a pair of secondary seals.

2. The traction battery pack as recited in claim 1, wherein a first primary seal of the pair of primary seals and a first secondary seal of the pair of secondary seals cooperate to seal an interface between the sealed busbar assembly and a first array outer housing of the first battery array.

3. The traction battery pack as recited in claim 2, wherein a second primary seal of the pair of primary seals and a second secondary seal of the pair of secondary seals cooperate to seal an interface between the sealed busbar assembly and a second array outer housing of the second battery array.

4. The traction battery pack as recited in claim 3, wherein a first fastener of the pair of fasteners is received through the busbar and a first high voltage array busbar of the first battery array to establish a first high voltage connection, and a second fastener of the pair of fasteners is received through the busbar and a second high voltage array busbar of the second battery array to establish a second high voltage connection.

5. The traction battery pack as recited in claim 4, wherein the first fastener is received by a first fastener housing of a first internal component of the first battery array, and the second fastener is received by a second fastener housing of a second internal component of the second battery array.

6. The traction battery pack as recited in claim 5, wherein the first internal component is a first array busbar frame of the first battery array, and the second internal component is a second array busbar frame of the second battery array.

7. The traction battery pack as recited in claim 1, wherein the busbar frame is overmolded around the busbar.

8. The traction battery pack as recited in claim 1, wherein each primary seal of the pair of primary seals is positioned within a groove of the busbar frame.

9. The traction battery pack as recited in claim 1, wherein each secondary seal of the pair of secondary seals is received within a groove of a head portion of a respective fastener of the pair of fasteners.

10. The traction battery pack as recited in claim 1, wherein the busbar frame includes a first cover movable to enclose a first tab section of the busbar and a second cover movable to enclose a second tab section of the busbar.

11. A traction battery pack, comprising:
a first battery array including a first high voltage array busbar; and
a sealed busbar assembly including a busbar positioned against the first high voltage array busbar, a first fastener received through the busbar and the first high voltage array busbar, a first primary seal, and a first secondary seal,
wherein the first primary seal and the first secondary seal cooperate to seal a first high voltage connection established by the first fastener, the busbar, and the first high voltage array busbar.

12. The traction battery pack as recited in claim 11, wherein the first primary seal is arranged to seal an interface between the sealed busbar assembly and a first array outer housing of the first battery array.

13. The traction battery pack as recited in claim 12, wherein the first primary seal is positioned within a groove of a busbar frame of the sealed busbar assembly.

14. The traction battery pack as recited in claim 13, wherein the busbar frame is overmolded around the busbar.

15. The traction battery pack as recited in claim 11, wherein the first secondary seal is arranged to seal an interface between the first fastener and the busbar.

16. The traction battery pack as recited in claim 15, wherein the first secondary seal is received within a groove of a head portion of the first fastener.

17. The traction battery pack as recited in claim 11, wherein the first fastener is received by a fastener housing of an internal component of the first battery array.

18. The traction battery pack as recited in claim 17, wherein the internal component is an array busbar frame of the first battery array.

19. The traction battery pack as recited in claim 11, wherein the sealed busbar assembly includes a second primary seal, a second secondary seal, and a second fastener received through the busbar and a second high voltage array busbar of a second battery array.

20. The traction battery pack as recited in claim 19, wherein the second primary seal and the second secondary seal cooperate to seal a second high voltage connection established by the second fastener, the busbar, and the second high voltage array busbar.
